(19) United States
(12) Patent Application Publication
(10) Pub. No.: US 2023/0156787 A1
(43) Pub. Date: May 18, 2023

(54) WIDEBAND SENSING REFERENCE SIGNAL

(71) Applicant: QUALCOMM Incorporated, San Diego, CA (US)

(72) Inventors: Jing DAI, Beijing (CN); Yuwei REN, Beijing (CN); Hao XU, Beijing (CN)

(21) Appl. No.: 17/995,041

(22) PCT Filed: May 27, 2020
(86) PCT No.: PCT/CN2020/092509

§ 371 Date: Sep. 29, 2022

(51) Int. Cl. H04W 74/08; H04L 5/00; H04W 72/11

(52) U.S. Cl. CPC H04W 74/0808; H04L 5/0051; H04W 72/11; H04L 5/0012

(57) ABSTRACT

Various aspects of the present disclosure generally relate to wireless communication. In son aspects, a wireless communication device may determine a configuration for a sensing reference signal to be transmitted by the wireless communication device, wherein the configuration is associated with a wideband structure; transmit the sensing reference signal in accordance with the configuration; and perform a wireless sensing operation based at least in part on receiving sensor information and based at least in part on the configuration. Numerous other aspects are provided.

### FIELD OF THE DISCLOSURE

Aspects of the present disclosure generally relate to wireless communication and to techniques and apparatuses for a wideband sensing reference signal (S-RS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a wireless communication device, may include determining a configuration for a sensing reference signal to be transmitted by the wireless communication device, wherein the configuration is associated with a wideband structure; transmitting the sensing reference signal in accordance with the configuration; and performing a wireless sensing operation based at least in part on receiving sensor information and based at least in part on the configuration.

In some aspects, a method of wireless communication, performed by a network entity, may include determining a configuration for a sensing reference signal to be transmitted by a wireless communication device, wherein the configuration is associated with a wideband structure; and transmitting, to the wireless communication device, information indicating the configuration.

In some aspects, a wireless communication device for wireless communication may include a memory and one or more processors operatively coupled to the memory. The memory and the one or more processors may be configured to determine a configuration for a sensing reference signal to be transmitted by the wireless communication device, wherein the configuration is associated with a wideband structure; transmit the sensing reference signal in accordance with the configuration; and perform a wireless sensing operation based at least in part on receiving sensor information and based at least in part on the configuration.

In some aspects, a network entity for wireless communication may include a memory and one or more processors operatively coupled to the memory. The memory and the one or more processors may be configured to determine a configuration for a sensing reference signal to be transmitted by a wireless communication device, wherein the configuration is associated with a wideband structure; and transmit, to the wireless communication device, information indicating the configuration.

In some aspects, a non-transitory computer-readable medium may store one or more instructions for wireless communication. The one or more instructions, when executed by one or more processors of a wireless communication device, may cause the one or more processors to determine a configuration for a sensing reference signal to be transmitted by the wireless communication device, wherein the configuration is associated with a wideband structure; transmit the sensing reference signal in accordance with the configuration; and perform a wireless sensing operation based at least in part on receiving sensor information and based at least in part on the configuration.

In some aspects, a non-transitory computer-readable medium may store one or more instructions for wireless communication. The one or more instructions, when executed by one or more processors of a network entity, may cause the one or more processors to determine a configuration for a sensing reference signal to be transmitted by a wireless communication device, wherein the configuration is associated with a wideband structure; and transmit, to the wireless communication device, information indicating the configuration.

In some aspects, an apparatus for wireless communication may include means for determining a configuration for a sensing reference signal to be transmitted by the apparatus, wherein the configuration is associated with a wideband structure; means for transmitting the sensing reference signal in accordance with the configuration; and means for performing a wireless sensing operation based at least in part on receiving sensor information and based at least in part on the configuration.

In some aspects, an apparatus for wireless communication may include means for determining a configuration for a sensing reference signal to be transmitted by a wireless communication device, wherein the configuration is associated with a wideband structure; and means for transmitting, to the wireless communication device, information indicating the configuration.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of configuring and transmitting a sensing reference signal using a wideband structure for a wireless sensing operation, in accordance with various aspects of the present disclosure.

FIG. 4 is a diagram illustrating an example table associated with a configuration for a sensing reference signal, in accordance with various aspects of the present disclosure.

FIG. 5 is a diagram illustrating an example table associated with a bandwidth-based configuration for a sensing reference signal, in accordance with various aspects of the present disclosure.

FIG. 6 is a diagram illustrating an example of a staggering pattern for sensing reference signal elements in a wideband structure, in accordance with various aspects of the present disclosure.

FIG. 7 is a diagram illustrating an example of a table indicating staggering patterns for corresponding comb sizes and lengths of sensing reference signals, in accordance with various aspects of the present disclosure.

FIG. 8 is a diagram illustrating an example of frequency hopping at a sub-band granularity with the same staggering pattern at each hop, and an example of frequency hopping at a sub-band granularity with different staggering patterns at each hop, in accordance with various aspects of the present disclosure.

FIG. 9 is a diagram illustrating an example of frequency hopping at a sub-band granularity with a tuning gap, in accordance with various aspects of the present disclosure.

FIGS. 10-11 are diagrams illustrating example processes associated with wireless sensing using a wideband sensing reference signal, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

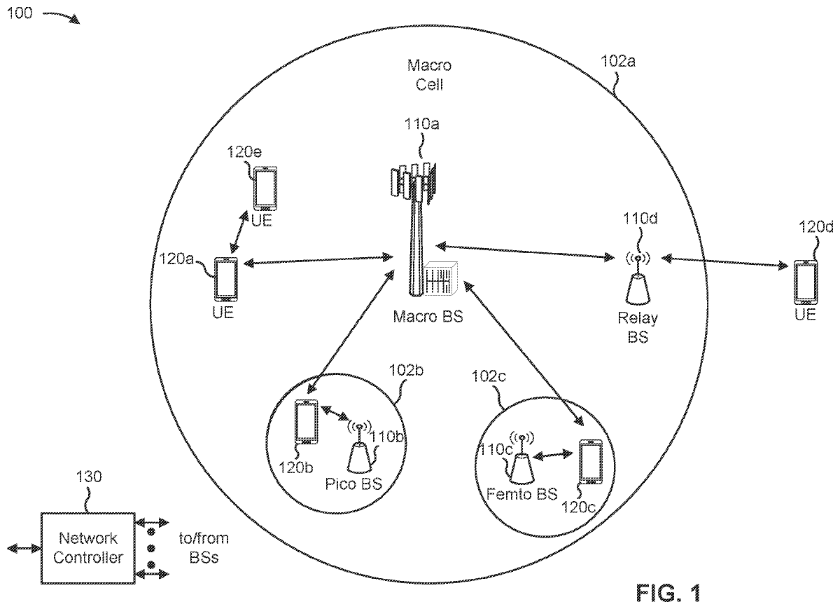

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

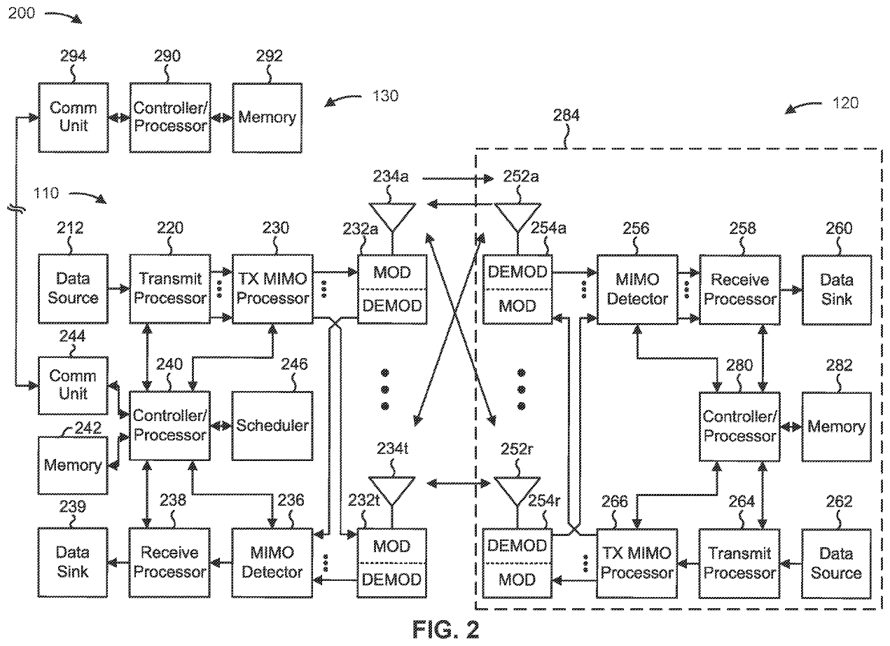

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

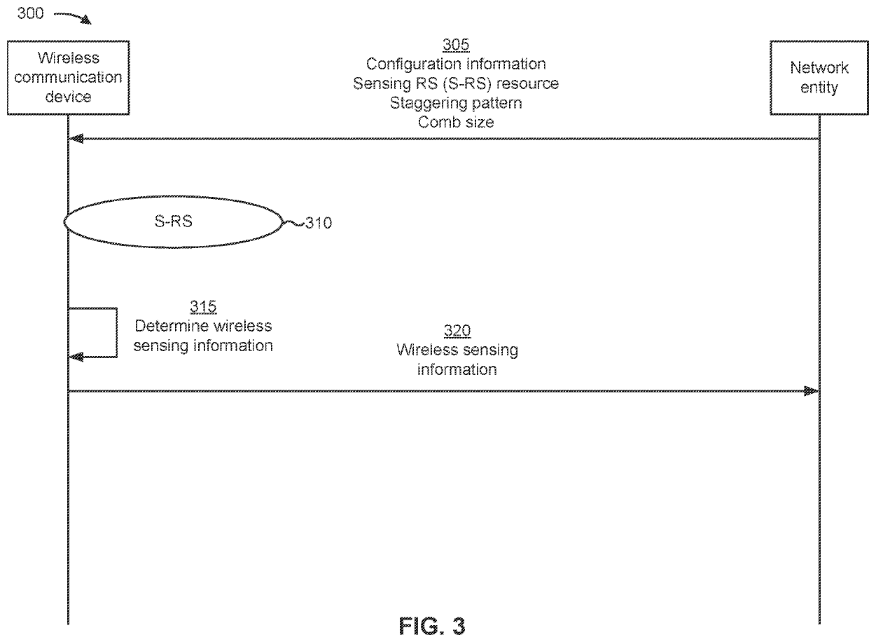

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-11.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-11.

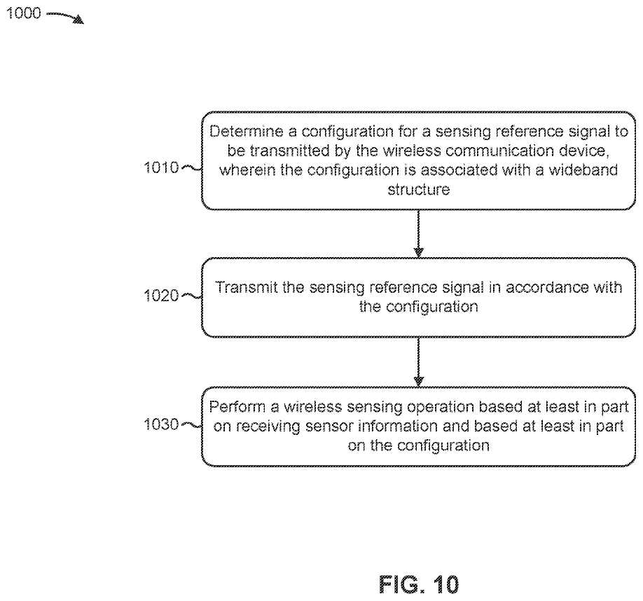

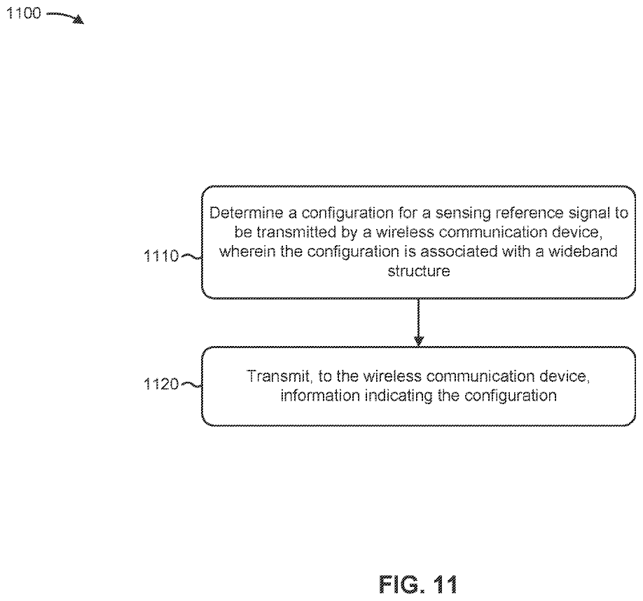

Controller/processor 240 of base station 110, controller/processor 280 of UE 120, and/or any other component(s) of FIG. 2 may perform one or more techniques associated with a wideband sensing reference signal (S-RS), as described in more detail elsewhere herein. For example, controller/processor 240 of base station 110, controller/processor 280 of UE 120, and/or any other component(s) of FIG. 2 may perform or direct operations of, for example, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some aspects, executing instructions may include running the instructions, converting the instructions, compiling the instructions, interpreting the instructions, and/or the like.

In some aspects, a wireless communication device (e.g., UE 120, BS 110, a CPE, an integrated access backhaul node, and/or the like) may include means for determining a configuration for a sensing reference signal to be transmitted by the wireless communication device, wherein the configuration is associated with a wideband structure; means for transmitting the sensing reference signal in accordance with the configuration; means for performing a wireless sensing operation based at least in part on receiving sensor information and based at least in part on the configuration; means for identifying a collision between one or more symbols of the sensing reference signal and an uplink channel; means for dropping the one or more symbols of the sensing reference signal based at least in part on the collision; means for receiving information indicating the configuration; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a network entity (e.g., base station 110, a 5G network entity, a next generation radio access network (NG-RAN), and/or the like) may include means for determining a configuration for a sensing reference signal to be transmitted by a wireless communication device, wherein the configuration is associated with a wideband structure; means for transmitting, to the wireless communication device, information indicating the configuration; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of processor 280.

As indicated above, FIG. 2 is provided as an example. Other examples may differ from what is described with regard to FIG. 2.

A wireless communication device may perform a wireless sensing operation, for example, to support imaging of an environment associated with the wireless communication device. For example, higher frequency bands (e.g., millimeter wave (mmW or mmWave) bands, terahertz (THz) bands, and/or the like) may provide a high bandwidth and a large aperture for the determination of accurate range information, Doppler information, angle information, and/or the like, in comparison to lower frequency bands. A wireless sensing operation may include transmission of a waveform by a transmission component of a wireless communication device, sensing of reflected signals by a reception component of the wireless communication device, signal processing to correlate transmitted signals with received signals, and processing to identify an object, action, and/or the like. Wireless sensing may be useful for industrial Internet of Things (IoT), augmented reality, virtual reality, automotive applications, gaming applications, touchless interaction, and/or the like. Wireless sensing can be performed on the downlink (e.g., access point based radar sensing to determine a person's motions or actions) and on the uplink (e.g., UE based proximity sensing for user/machine interaction or awareness of other information).

Generally, wireless sensing may be more effective when performed using a signal with a wider bandwidth than when performed using a signal with a narrower bandwidth. For example, a range resolution of a wireless sensing operation, which may indicate a resolution at which the range of a sensed object can be determined, may be inversely proportionate to a bandwidth of a signal used to perform the wireless sensing operation. More particularly, the range resolution may be defined by c/2B, where c is the speed of light and B is the utilized bandwidth. Thus, a larger value of B may lead to a higher range resolution. In some cases, bandwidth may be a constraint for a UE's capability to perform a wireless sensing operation. For example, in Frequency Range 1 (FR1) of 5G/NR, the maximum bandwidth may be 100 MHz, and in Frequency Range 2 (FR2) of 5G/NR, the maximum bandwidth may be 400 MHz. Some wireless sensing configurations may use multiple component carriers (e.g., in a carrier aggregation (CA) configuration) to transmit a signal for wireless sensing on a wider bandwidth than would otherwise be achievable. However, complications may arise in signal design for a wideband wireless sensing signal, such as how to distribute resource elements of the wideband wireless sensing signal within a sub-band, how to distribute resource elements of the wideband wireless sensing signal across multiple sub-bands, and/or the like. Without a technique for distributing wideband resource elements across a wideband including one or more sub-bands, frequency diversity may suffer, thereby negatively impacting the performance of the wireless sensing operation due to interference on certain frequencies.

Some techniques and apparatuses described herein provide a configuration for a sensing reference signal (S-RS) for a wireless sensing operation. For example, some techniques and apparatuses described herein provide a wideband configuration with a staggering pattern so that the S-RS is distributed in frequency and/or in time within a sub-band and/or across sub-bands. Furthermore, some techniques and apparatuses described herein define relationships for configuring an S-RS, such as a relationship between a comb size and a length of the S-RS, a relationship between a bandwidth of the S-RS and available comb sizes of the S-RS, and sequences used to generate the S-RS. Thus, frequency diversity of the S-RS is improved, thereby improving performance of wireless sensing operations that use wideband reference signals and enabling the utilization of multiple component carriers or sub-bands for transmission of the S-RS.

FIG. 3 is a diagram illustrating an example 300 of configuring and transmitting a sensing reference signal using a wideband structure for a wireless sensing operation, in accordance with various aspects of the present disclosure. As shown, example 300 includes a wireless communication device and a network entity. The wireless communication device may include, for example, a UE 120, a BS 110, a CPE, an IAB node, an access point, and/or the like. The network entity may include, for example, a BS 110, an NG-RAN, an IAB node, a central unit (CU), and/or the like.

As shown by reference number 305, the network entity may transmit configuration information to the wireless communication device. The configuration information may include information identifying a configuration for a sensing reference signal (S-RS) to be transmitted by the wireless communication device. The S-RS may be an uplink reference signal or a downlink reference signal. In one example, configuration information may indicate an S-RS resource for the S-RS. As another example, the configuration information may indicate a staggering pattern for the S-RS. In some aspects, the configuration information may indicate a staggering pattern for the S-RS and/or a comb size for the S-RS. In other aspects, the staggering pattern and/or comb size may be determined by the wireless communication device based at least in part on the configuration information and one or more other parameters. A comb size of N may indicate that an S-RS is to be transmitted on every Nth resource element. For example, a comb size of 2 may indicate that an S-RS is to be mapped to every second resource element. A larger comb size may be more resource-efficient, such as for larger bandwidths, whereas a smaller comb size may provide increased resolution for wireless sensing at the cost of higher transmit power and resource usage. A staggering pattern may indicate how the S-RS is to be mapped to resource elements in the frequency domain.

In some aspects, the S-RS resource may be flexible in time and/or frequency resource allocation. For example, the configuration information may include time-domain scheduling information. In such a case, the S-RS resource may be scheduled periodically, semi-persistently, or as an aperiodic resource. The time-domain scheduling information may be provided via radio resource control (RRC) signaling, a medium access control (MAC) control element (CE), downlink control information (DCI), or a combination thereof. Additionally, or alternatively, the configuration information may be provided via RRC signaling, a MAC-CE, DCI, or a combination thereof.

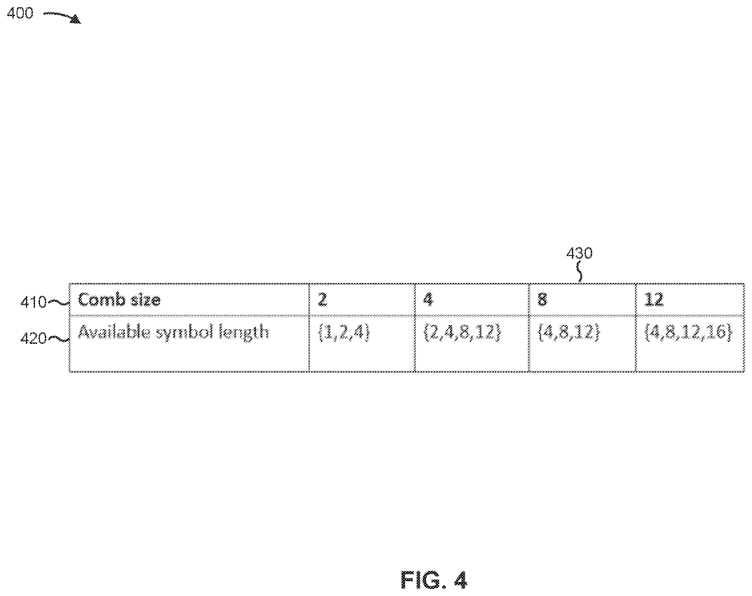

In some aspects, the S-RS may be a multi-symbol S-RS. In some aspects, a length of an S-RS may be based at least in part on a table. FIG. 4 is a diagram illustrating an example table 400 associated with a configuration for a sensing reference signal, in accordance with various aspects of the present disclosure. Table 400 indicates a relationship between comb size (shown by reference number 410) and available symbol lengths for an S-RS (shown by reference number 420). In some aspects, table 400 may be configured as part of the configuration information 410, or may be configured separately from the configuration information 410. As an example shown by reference number 430, for a comb size of 8, the S-RS may have available lengths of 4 symbols, 8 symbols, or 12 symbols. In some aspects, the length of the S-RS may be selected from the available lengths for a given comb size, and may be indicated to the wireless communication device using RRC signaling, a MAC-CE, DCI, or a combination thereof. In some aspects, the configuration information 410 may indicate the selected length of the S-RS (e.g., if the table 400 is pre-configured prior to receiving the configuration information 410).

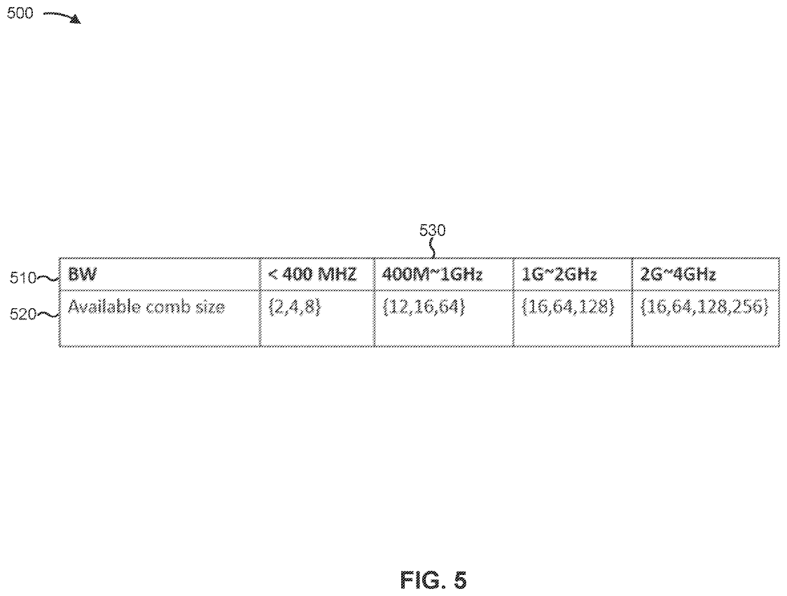

In some aspects, the comb size may be based at least in part on a bandwidth of the S-RS resource. For example, comb size may have a positive correlation with the bandwidth of the S-RS. In some aspects, available values for a comb size at a given bandwidth may be indicated by a table. FIG. 5 is a diagram illustrating an example table 500 associated with a bandwidth-based configuration for a sensing reference signal, in accordance with various aspects of the present disclosure. Table 500 indicates a relationship between bandwidth (shown by reference number 510) and available comb size values (shown by reference number 520). It can be seen that comb sizes are generally larger for wider bandwidths. For example, for a bandwidth of between 400 MHz and 1 GHz, shown by reference number 530, available comb sizes include 12, 16, and 64. A selected comb size may be indicated using RRC signaling, a MAC-CE, DCI, and/or the like. In some aspects, the configuration information 305 may indicate a selected comb size (e.g., if the table 500 is configured prior to receiving the configuration information 305). In some aspects, the configuration information 305 may indicate the table 500, and subsequent signaling may indicate the selected comb size.

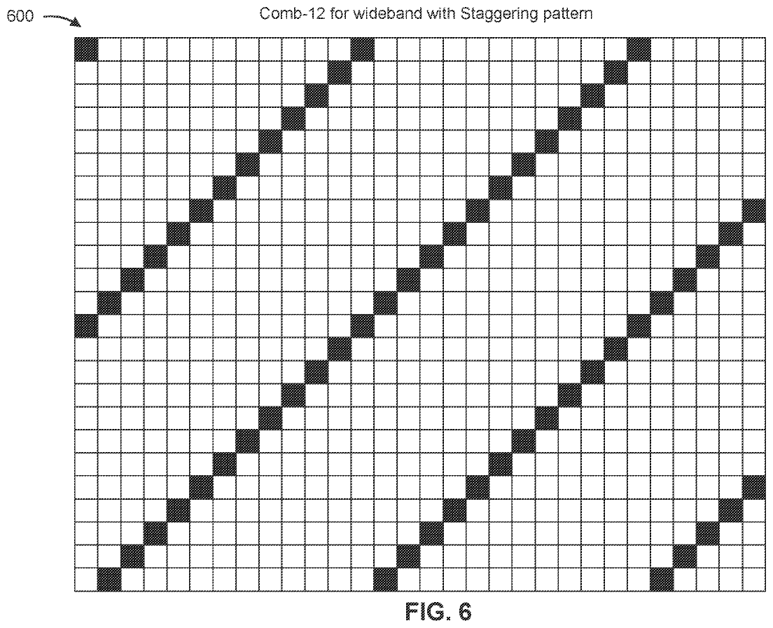

FIG. 6 is a diagram illustrating an example 600 of a resource mapping for a sensing reference signal with a comb size of 12 in a wideband structure, in accordance with various aspects of the present disclosure. For example, the resource mapping of example 600 may be associated with a bandwidth between 400 MHz and 1 GHz if table 500 is used to determine the comb size. It can be seen in example 600 that resource elements to which the S-RS is to be mapped are spaced every 12 resource elements in the frequency domain. Furthermore, the resource elements are staggered in a diagonal fashion, which may be indicated by a staggering pattern of the configuration information 305.

In some aspects, the comb size may be determined based at least in part on the bandwidth. For example, the comb size may be related to the bandwidth by an equation. One example of such an equation is combsize=└log₂BW┘ (e.g., the comb size is equal to the floor of the logarithm base 2 of the bandwidth of the S-RS). In some aspects, the equation may be configured by the configuration information 305, or may be pre-configured (e.g., as part of a wireless communication specification, by a manufacturer or servicer of the wireless communication device, and/or the like).

The staggering pattern may provide for frequency diversity of the S-RS by indicating how the S-RS is to be mapped to frequency resources. One example of a staggering pattern is provided in example 600. In example 600, the staggering pattern indicates that the S-RS is to be mapped to increasing frequency-domain resource elements across the time domain. The staggering pattern of example 600, for a comb size of 12, may be represented by {0, 1, 2, 3, 4, 5, 6, 7, 8, 9, 10, 11, 12}, where each index indicates a frequency offset for a corresponding symbol of the S-RS.

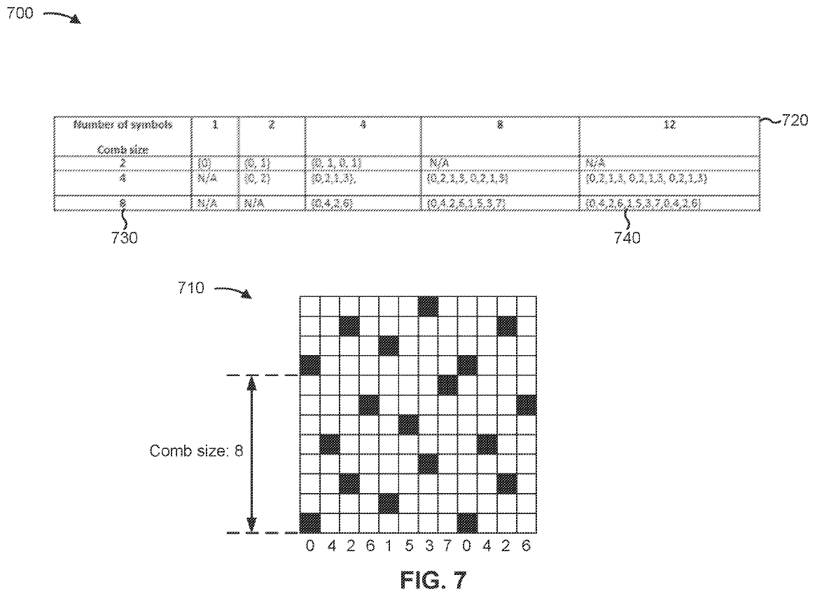

Additional examples of staggering patterns are provided in FIG. 7. FIG. 7 is a diagram illustrating an example of a table 700 indicating staggering patterns for corresponding comb sizes and lengths of sensing reference signals, in accordance with various aspects of the present disclosure. FIG. 7 also illustrates a mapping 710 based at least in part on a staggering pattern indicated by table 700. Table 700 may be configured by the configuration information 305, or may be configured prior to receiving the configuration information 305. Table 700 may be configured using RRC signaling, a MAC-CE, DCI, or a combination thereof.

Table 700 indicates a staggering pattern for an S-RS based at least in part on a length of the S-RS (e.g., a number of symbols, shown by reference number 720) and a comb size of the S-RS (shown by reference number 730). For example, a staggering pattern for an S-RS that is 12 symbols long with a comb size of 8 is shown by reference number 740. The corresponding mapping of the S-RS to resource elements is shown by reference number 710. Each index of the staggering pattern indicates an offset from a baseline frequency, and the index of 0 corresponds to the baseline frequency. The pattern is repeated based at least in part on the comb size in the frequency dimension, where the vertical direction in FIG. 7 indicates frequency and the horizontal direction in FIG. 7 indicates time. Furthermore, the pattern repeats after 8 symbols based at least in part on the comb size of 8.

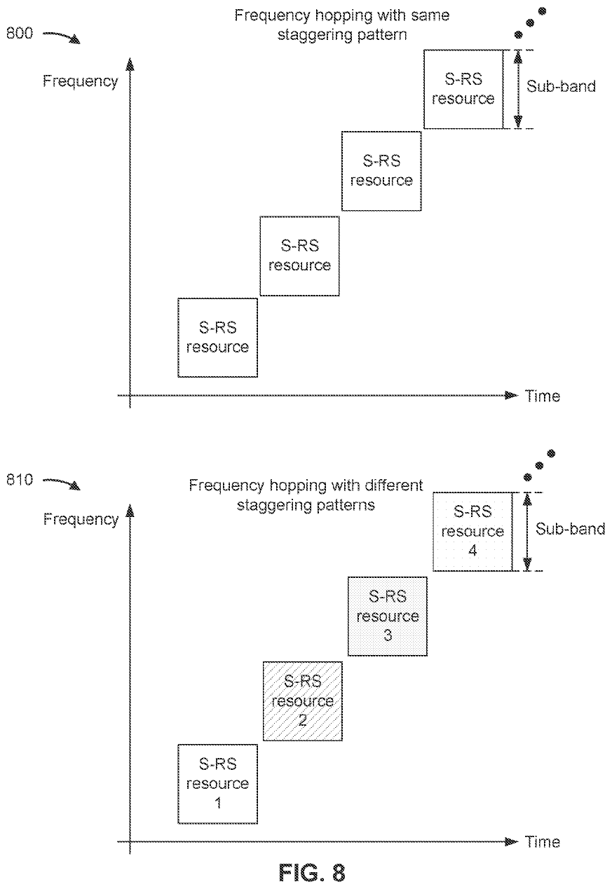

In some aspects, the S-RS may span multiple sub-bands or component carriers. For example, the S-RS may span a band. In such a case, in some aspects, the staggering pattern may be applied across the band (e.g., the staggering pattern may not be applied at a per-sub-band granularity). This is shown, for example, by the mapping 600. In other aspects, frequency hopping may be applied, in which the staggering pattern is applied at a per-sub-band or component carrier granularity and/or different staggering patterns are applied for different sub-bands or component carriers. FIG. 8 is a diagram illustrating an example 800 of frequency hopping at a sub-band granularity with the same staggering pattern at each hop, and an example 810 of frequency hopping at a sub-band granularity with different staggering patterns at each hop, in accordance with various aspects of the present disclosure. The sub-bands used for the frequency hopping described herein may be defined at a resource block (RB) level, meaning that a sub-band spans one RB, or an RB group level, meaning that a sub-band spans a group of one or more RBs.

In example 800, a same staggering pattern is used at each frequency hop, as indicated by the same fill being used for each S-RS resource. As shown, hopping is performed incrementally across sub-bands in the time domain, though the frequency hopping can use any pattern. In example 810, different staggering patterns are used at two or more frequency hops, indicated by different fills being used for four S-RS resources. In some aspects, any number of different staggering patterns can be used (e.g., two different staggering patterns, four different staggering patterns, and so on). Using different staggering patterns for two or more frequency hops may improve frequency diversity, while using a same staggering pattern for two or more frequency hops may reduce overhead.

In some cases, the S-RS resource may collide with an uplink channel. In such a case, the wireless communication device may drop a portion of the S-RS resource that collides with the uplink channel. For example, the wireless communication device may drop one or more symbols that collide with the uplink channel. In some aspects, the S-RS may be a symbol-level time domain resource pattern. For example, the configuration information may identify a symbol-level time domain resource pattern. In this case, certain symbols of a slot may be configured for the S-RS resource. In some aspects, the S-RS may be slot-level time domain resource pattern. For example, the configuration information may identify a slot-level time domain resource pattern. In this case, one or more slots (e.g., one or more continuous slots) may be configured for the S-RS resource.

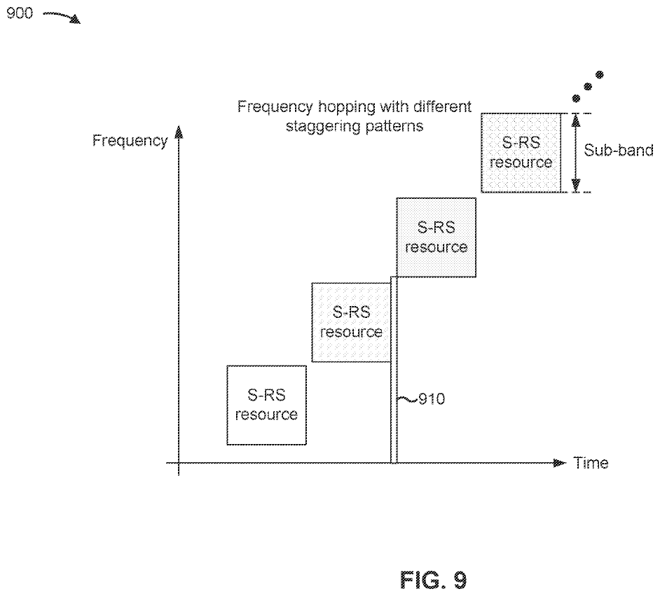

In some aspects, the configuration information may indicate one or more gaps associated with the S-RS symbol. A gap may be for radio frequency (RF) switching or tuning from one frequency to another. For example, the configuration information may indicate a gap prior to an S-RS resource for tuning from a communication frequency to a frequency associated with the S-RS resource. As another example, the configuration information may indicate a gap subsequent to an S-RS resource for tuning from the frequency associated with the S-RS resource to the tuning frequency. As a third example, the configuration information may indicate a gap for RF switching associated with frequency hopping between a first sub-band and a second sub-band during transmission of the S-RS For example, FIG. 9 is a diagram illustrating an example 900 of frequency hopping at a sub-band granularity with a gap 910, in accordance with various aspects of the present disclosure. In some aspects, the gap 910 may be configured between a first band and a second band. For example, in example 900, S-RS resource 1 and S-RS resource 2 may be in a first band to which the wireless communication device is tuned, and S-RS resource 3 and S-RS resource 4 may be in a second band to which the wireless communication device is not tuned. Thus, the configuration information may configure the gap 910 so that the wireless communication device can tune from the first band to the second band, thereby reducing interruption on the first band and/or the second band.

In some aspects, the configuration may indicate a sequence for generating an S-RS. In some aspects, the sequence may be based at least in part on a channel state information reference signal (CSI-RS) sequence. For example, the sequence may be a CSI-RS sequence for a downlink S-RS. In some aspects, the sequence may be based at least in part on a sounding reference signal sequence. For example, the sequence may be an SRS sequence for an uplink S-RS. In some aspects, the sequence may be defined based at least in part on a pi over 2 (pi/2) binary phase shift keying (BPSK) modulation order. In some aspects, the sequence may be defined based at least in part on one or more Zadoff-Chu sequences, which may be configured through sequence generation parameters specified by a 3GPP Technical Specification (TS), such as TS 38.211. In some aspects, the sequence may be defined based at least in part on a mapping of one or more sequence generation parameters (e.g., a number of layers, a subcarrier spacing, and/or the like) across orthogonal frequency division multiplexing (OFDM) symbols of a reference signal resource, such as an SRS resource or a CSI-RS resource.

As shown by reference number 310, the wireless communication device may transmit the S-RS in accordance with the configuration. For example, the wireless communication device may transmit the S-RS on one or more S-RS resources using a sequence indicated by the configuration. The wireless communication device may perform frequency hopping across sub-bands, or may transmit the S-RS on an operating band of the wireless communication device without performing frequency hopping.

As shown by reference number 315, the wireless communication device may determine wireless sensing information based at least in part on the S-RS. For example, the wireless communication device may receive signals based at least in part on the S-RS, and may determine wireless sensing information based at least in part on the S-RS. In some aspects, the wireless communication device may perform an operation based at least in part on the wireless sensing information. In some aspects, the wireless communication device may provide the wireless sensing information to the network entity. For example, the network entity may configure the wireless communication device to perform the wireless sensing operation to determine information regarding the wireless communication device's environment, and may use this information to perform one or more network functions.

As indicated above, FIGS. 3-9 are provided as one or more examples. Other examples may differ from what is described with respect to FIGS. 3-9.

FIG. 10 is a diagram illustrating an example process 1000 performed, for example, by a wireless communication device, in accordance with various aspects of the present disclosure. Example process 1000 is an example where the wireless communication device (e.g., a UE 120, a BS 110, a CPE, an IAB node, an access point, and/or the like) performs operations associated with a wideband S-RS.

As shown in FIG. 10, in some aspects, process 1000 may include determining a configuration for a sensing reference signal to be transmitted by the wireless communication device, wherein the configuration is associated with a wideband structure (block 1010). For example, the wireless communication device (e.g., using antenna 252, DEMOD 254, MIMO detector 256, receive processor 258, controller/processor 280, antenna 234, DEMOD 232, MIMO detector 236, receive processor 238, controller/processor 240, and/or the like) may determine a configuration for a sensing reference signal to be transmitted by the wireless communication device, as described above. In some aspects, the configuration is associated with a wideband structure.

As further shown in FIG. 10, in some aspects, process 1000 may include transmitting the sensing reference signal in accordance with the configuration (block 1020). For example, the wireless communication device (e.g., using controller/processor 280, transmit processor 264, TX MIMO processor 266, MOD 254, antenna 252, controller/processor 240, transmit processor 220, TX MIMO processor 230, MOD 232, antenna 234, and/or the like) may transmit the sensing reference signal in accordance with the configuration, as described above.

As further shown in FIG. 10, in some aspects, process 1000 may include performing a wireless sensing operation based at least in part on receiving sensor information and based at least in part on the configuration (block 1030). For example, the wireless communication device (e.g., using antenna 252, DEMOD 254, MIMO detector 256, receive processor 258, controller/processor 280, antenna 234, DEMOD 232, MIMO detector 236, receive processor 238, controller/processor 240, and/or the like) may perform a wireless sensing operation based at least in part on receiving sensor information and based at least in part on the configuration, as described above.

Process 1000 may include additional aspects, such as any single aspect or any combination of aspects described below and/or in connection with one or more other processes described elsewhere herein.

In a first aspect, the configuration is associated with at least one of a flexible time resource allocation or a flexible frequency resource allocation.

In a second aspect, alone or in combination with the first aspect, the configuration indicates scheduling information for the sensing reference signal.

In a third aspect, alone or in combination with one or more of the first and second aspects, the scheduling information includes at least one of: periodic scheduling information, semi-persistent scheduling information, or aperiodic scheduling information.

In a fourth aspect, alone or in combination with one or more of the first through third aspects, the scheduling information is received via at least one of: radio resource control signaling, medium access control signaling, or downlink control information.

In a fifth aspect, alone or in combination with one or more of the first through fourth aspects, the configuration indicates a staggering pattern for the sensing reference signal.

In a sixth aspect, alone or in combination with one or more of the first through fifth aspects, the staggering pattern indicates frequency locations over multiple symbols of the sensing reference signal.

In a seventh aspect, alone or in combination with one or more of the first through sixth aspects, the configuration indicates a length of the sensing reference signal based at least in part on a comb size associated with the sensing reference signal.

In an eighth aspect, alone or in combination with one or more of the first through seventh aspects, a comb size of the staggering pattern is based at least in part on a bandwidth configuration of the wideband structure.

In a ninth aspect, alone or in combination with one or more of the first through eighth aspects, the comb size is indicated by a table entry corresponding to the bandwidth configuration of the wideband structure.

In a tenth aspect, alone or in combination with one or more of the first through ninth aspects, the comb size is determined based at least in part on signaling received from a base station.

In an eleventh aspect, alone or in combination with one or more of the first through tenth aspects, frequency locations of the staggering pattern are defined based at least in part on a number of symbols of the sensing reference signal and a comb size of the staggering pattern.

In a twelfth aspect, alone or in combination with one or more of the first through eleventh aspects, the staggering pattern spans an entire bandwidth of the wideband structure.

In a thirteenth aspect, alone or in combination with one or more of the first through twelfth aspects, the staggering pattern spans a sub-band of the wideband structure, and the staggering pattern is used in multiple sub-bands of the wideband structure with a frequency hopping pattern.

In a fourteenth aspect, alone or in combination with one or more of the first through thirteenth aspects, the sub-band is defined based at least in part on a resource block.

In a fifteenth aspect, alone or in combination with one or more of the first through fourteenth aspects, the sub-band is defined based at least in part on a resource block group.

In a sixteenth aspect, alone or in combination with one or more of the first through fifteenth aspects, a plurality of staggering patterns are used for respective sub-bands of the wideband structure.

In a seventeenth aspect, alone or in combination with one or more of the first through sixteenth aspects, the respective sub-bands are defined based at least in part on resource blocks.

In an eighteenth aspect, alone or in combination with one or more of the first through seventeenth aspects, the sub-band is defined based at least in part on resource block groups.

In a nineteenth aspect, alone or in combination with one or more of the first through eighteenth aspects, the configuration indicates a dedicated resource for the sensing reference signal.

In a twentieth aspect, alone or in combination with one or more of the first through nineteenth aspects, process 1000 includes identifying a collision between one or more symbols of the sensing reference signal and an uplink channel; and dropping the one or more symbols of the sensing reference signal based at least in part on the collision.

In a twenty-first aspect, alone or in combination with one or more of the first through twentieth aspects, the configuration identifies a symbol-level time domain resource pattern for the wireless sensing signal.

In a twenty-second aspect, alone or in combination with one or more of the first through twenty-first aspects, the configuration identifies a slot-level time domain resource pattern for the wireless sensing signal.

In a twenty-third aspect, alone or in combination with one or more of the first through twenty-second aspects, the configuration indicates a gap for radio frequency switching before the sensing reference signal is transmitted.

In a twenty-fourth aspect, alone or in combination with one or more of the first through twenty-third aspects, the configuration indicates a gap for radio frequency switching associated with frequency hopping between a first sub-band and a second sub-band during transmission of the sensing reference signal.

In a twenty-fifth aspect, alone or in combination with one or more of the first through twenty-fourth aspects, the configuration indicates a sequence for the sensing reference signal.

In a twenty-sixth aspect, alone or in combination with one or more of the first through twenty-fifth aspects, the sequence is based at least in part on a sequence used for a channel state information reference signal.

In a twenty-seventh aspect, alone or in combination with one or more of the first through twenty-sixth aspects, the sequence is based at least in part on a sequence used for a sounding reference signal.

In a twenty-eighth aspect, alone or in combination with one or more of the first through twenty-seventh aspects, the sequence is based at least in part on a pi divided by 2 (π/2) binary phase shift keying modulation scheme.

In a twenty-ninth aspect, alone or in combination with one or more of the first through twenty-eighth aspects, the sequence is based at least in part on one or more Zadoff-Chu sequences.

In a thirtieth aspect, alone or in combination with one or more of the first through twenty ninth aspects, the sequence is based at least in part on a modified sequence for a channel state information reference signal.

In a thirty-first aspect, alone or in combination with one or more of the first through thirtieth aspects, the sensing reference signal is transmitted in a millimeter wave band.

In a thirty-second aspect, alone or in combination with one or more of the first through thirty-first aspects, the sensing reference signal is transmitted in a terahertz band.

In a thirty-third aspect, alone or in combination with one or more of the first through thirty-second aspects, the sensing reference signal is transmitted in a band above 24 gigahertz.

In a thirty-fourth aspect, alone or in combination with one or more of the first through thirty-third aspects, the sensing reference signal is a downlink signal.

In a thirty-fifth aspect, alone or in combination with one or more of the first through thirty-fourth aspects, the sensing reference signal is an uplink signal.

In a thirty-sixth aspect, alone or in combination with one or more of the first through thirty-fifth aspects, determining the configuration further comprises receiving information indicating the configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with various aspects of the present disclosure. Example process 1100 is an example where the network entity (e.g., BS 110, an NG-RAN, an IAB node, a CU, and/or the like) performs operations associated with configuring a wideband sensing reference signal.

As shown in FIG. 11, in some aspects, process 1100 may include determining a configuration for a sensing reference signal to be transmitted by a wireless communication device, wherein the configuration is associated with a wideband structure (block 1110). For example, the network entity (e.g., using controller/processor 240 and/or the like) may determine a configuration for a sensing reference signal to be transmitted by a wireless communication device, as described above. In some aspects, the configuration is associated with a wideband structure.

As further shown in FIG. 11, in some aspects, process 1100 may include transmitting, to the wireless communication device, information indicating the configuration (block 1120). For example, the network entity (e.g., using controller/processor 240, transmit processor 220, TX MIMO processor 230, MOD 232, antenna 234, and/or the like) may transmit, to the wireless communication device, information indicating the configuration, as described above.

Process 1100 may include additional aspects, such as any single aspect or any combination of aspects described below and/or in connection with one or more other processes described elsewhere herein.

In a first aspect, the configuration is associated with at least one of a flexible time resource allocation or a flexible frequency resource allocation.

In a second aspect, alone or in combination with the first aspect, the configuration indicates scheduling information for the sensing reference signal.

In a third aspect, alone or in combination with one or more of the first and second aspects, the scheduling information includes at least one of: periodic scheduling information, semi-persistent scheduling information, or aperiodic scheduling information.

In a fourth aspect, alone or in combination with one or more of the first through third aspects, the scheduling information is transmitted via at least one of: radio resource control signaling, medium access control signaling, or downlink control information.

In a fifth aspect, alone or in combination with one or more of the first through fourth aspects, the configuration indicates a staggering pattern for the sensing reference signal.

In a sixth aspect, alone or in combination with one or more of the first through fifth aspects, the staggering pattern indicates frequency locations over multiple symbols of the sensing reference signal.

In a seventh aspect, alone or in combination with one or more of the first through sixth aspects, the configuration indicates a length of the sensing reference signal based at least in part on a comb size associated with the sensing reference signal.

In an eighth aspect, alone or in combination with one or more of the first through seventh aspects, a comb size of the staggering pattern is based at least in part on a bandwidth configuration of the wideband structure.

In a ninth aspect, alone or in combination with one or more of the first through eighth aspects, the comb size is indicated by a table entry corresponding to the bandwidth configuration of the wideband structure.

In a tenth aspect, alone or in combination with one or more of the first through ninth aspects, the comb size is determined based at least in part on signaling received from a base station.

In an eleventh aspect, alone or in combination with one or more of the first through tenth aspects, frequency locations of the staggering pattern are defined based at least in part on a number of symbols of the sensing reference signal and a comb size of the staggering pattern.

In a twelfth aspect, alone or in combination with one or more of the first through eleventh aspects, the staggering pattern spans an entire bandwidth of the wideband structure.

In a thirteenth aspect, alone or in combination with one or more of the first through twelfth aspects, the staggering pattern spans a sub-band of the wideband structure, and the staggering pattern is used in multiple sub-bands of the wideband structure with a frequency hopping pattern.

In a fourteenth aspect, alone or in combination with one or more of the first through thirteenth aspects, the sub-band is defined based at least in part on a resource block.

In a fifteenth aspect, alone or in combination with one or more of the first through fourteenth aspects, the sub-band is defined based at least in part on a resource block group.

In a sixteenth aspect, alone or in combination with one or more of the first through fifteenth aspects, a plurality of staggering patterns are used for respective sub-bands of the wideband structure.

In a seventeenth aspect, alone or in combination with one or more of the first through sixteenth aspects, the respective sub-bands are defined based at least in part on resource blocks.

In an eighteenth aspect, alone or in combination with one or more of the first through seventeenth aspects, the sub-band is defined based at least in part on resource block groups.

In a nineteenth aspect, alone or in combination with one or more of the first through eighteenth aspects, the configuration indicates a dedicated resource for the sensing reference signal.

In a twentieth aspect, alone or in combination with one or more of the first through nineteenth aspects, the configuration identifies a symbol-level time domain resource pattern for the wireless sensing signal.

In a twenty-first aspect, alone or in combination with one or more of the first through twentieth aspects, the configuration identifies a slot-level time domain resource pattern for the wireless sensing signal.

In a twenty-second aspect, alone or in combination with one or more of the first through twenty-first aspects, the configuration indicates a gap for radio frequency switching before the sensing reference signal is transmitted.

In a twenty-third aspect, alone or in combination with one or more of the first through twenty-second aspects, the configuration indicates a gap for radio frequency switching associated with frequency hopping between a first sub-band and a second sub-band during transmission of the sensing reference signal.

In a twenty-fourth aspect, alone or in combination with one or more of the first through twenty-third aspects, the configuration indicates a sequence for the sensing reference signal.

In a twenty-fifth aspect, alone or in combination with one or more of the first through twenty-fourth aspects, the sequence is based at least in part on a sequence used for a channel state information reference signal.

In a twenty-sixth aspect, alone or in combination with one or more of the first through twenty-fifth aspects, the sequence is based at least in part on a sequence used for a sounding reference signal.

In a twenty-seventh aspect, alone or in combination with one or more of the first through twenty-sixth aspects, the sequence is based at least in part on a pi divided by 2 (π/2) binary phase shift keying modulation scheme.

In a twenty-eighth aspect, alone or in combination with one or more of the first through twenty-seventh aspects, the sequence is based at least in part on one or more Zadoff-Chu sequences.

In a twenty-ninth aspect, alone or in combination with one or more of the first through twenty-eighth aspects, the sequence is based at least in part on a modified sequence for a channel state information reference signal.

In a thirtieth aspect, alone or in combination with one or more of the first through twenty-ninth aspects, the sensing reference signal is a downlink signal.

In a thirty-first aspect, alone or in combination with one or more of the first through thirtieth aspects, the sensing reference signal is an uplink signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a wireless communication device, comprising:
determining a configuration for a sensing reference signal to be transmitted by the wireless communication device, wherein the configuration is associated with a wideband structure;
transmitting the sensing reference signal in accordance with the configuration; and
performing a wireless sensing operation based at least in part on receiving sensor information and based at least in part on the configuration.

2. The method of claim 1, wherein the configuration is associated with at least one of a flexible time resource allocation or a flexible frequency resource allocation.

3. The method of claim 1, wherein the configuration indicates scheduling information for the sensing reference signal.

4. The method of claim 3, wherein the scheduling information includes at least one of:
periodic scheduling information,
semi-persistent scheduling information, or
aperiodic scheduling information.

5. The method of claim 3, wherein the scheduling information is received via at least one of:
radio resource control signaling,
medium access control signaling, or
downlink control information.

6. The method of claim 1, wherein the configuration indicates a staggering pattern for the sensing reference signal.

7. The method of claim 6, wherein the staggering pattern indicates frequency locations over multiple symbols of the sensing reference signal.

8. The method of claim 6, wherein the configuration indicates a length of the sensing reference signal based at least in part on a comb size associated with the sensing reference signal.

9. The method of claim 6, wherein a comb size of the staggering pattern is based at least in part on a bandwidth configuration of the wideband structure.

10. The method of claim 9, wherein the comb size is indicated by a table entry corresponding to the bandwidth configuration of the wideband structure.

11. The method of claim 9, wherein the comb size is determined based at least in part on signaling received from a base station.

12. The method of claim 6, wherein frequency locations of the staggering pattern are defined based at least in part on a number of symbols of the sensing reference signal and a comb size of the staggering pattern.

13. The method of claim 6, wherein the staggering pattern spans an entire bandwidth of the wideband structure.

14. The method of claim 6, wherein the staggering pattern spans a sub-band of the wideband structure, and wherein the staggering pattern is used in multiple sub-bands of the wideband structure with a frequency hopping pattern.

15. The method of claim 14, wherein the sub-band is defined based at least in part on a resource block.

16. The method of claim 14, wherein the sub-band is defined based at least in part on a resource block group.

17. The method of claim 6, wherein a plurality of staggering patterns are used for respective sub-bands of the wideband structure.

18. The method of claim 17, wherein the respective sub-bands are defined based at least in part on resource blocks.

19. The method of claim 17, wherein the sub-band is defined based at least in part on resource block groups.

20. The method of claim 1, wherein the configuration indicates a dedicated resource for the sensing reference signal.

21. The method of claim 1, further comprising:
identifying a collision between one or more symbols of the sensing reference signal and an uplink channel; and
dropping the one or more symbols of the sensing reference signal based at least in part on the collision.

22. The method of claim 1, wherein the configuration identifies a symbol-level time domain resource pattern for the wireless sensing signal.

23. The method of claim 1, wherein the configuration identifies a slot-level time domain resource pattern for the wireless sensing signal.

24. The method of claim 1, wherein the configuration indicates a gap for radio frequency switching before the sensing reference signal is transmitted.

25. The method of claim 1, wherein the configuration indicates a gap for radio frequency switching associated with frequency hopping between a first sub-band and a second sub-band during transmission of the sensing reference signal.

26. The method of claim 1, wherein the configuration indicates a sequence for the sensing reference signal.

27. The method of claim 26, wherein the sequence is based at least in part on a sequence used for a channel state information reference signal.

28. The method of claim 26, wherein the sequence is based at least in part on a sequence used for a sounding reference signal.

29. The method of claim 26, wherein the sequence is based at least in part on a pi divided by 2 (π/2) binary phase shift keying modulation scheme.

30. The method of claim 26, wherein the sequence is based at least in part on one or more Zadoff-Chu sequences.

31. The method of claim 26, wherein the sequence is based at least in part on a modified sequence for a channel state information reference signal.

32. The method of claim 1, wherein the sensing reference signal is transmitted in a millimeter wave band.

33. The method of claim 1, wherein the sensing reference signal is transmitted in a terahertz band.

34. The method of claim 1, wherein the sensing reference signal is transmitted in a band above 24 gigahertz.

35. The method of claim 1, wherein the sensing reference signal is a downlink signal.

36. The method of claim 1, wherein the sensing reference signal is an uplink signal.

37. The method of claim 1, wherein determining the configuration further comprises:
receiving information indicating the configuration.

38. A method of wireless communication performed by a network entity, comprising:
determining a configuration for a sensing reference signal to be transmitted by a wireless communication device, wherein the configuration is associated with a wideband structure, and
transmitting, to the wireless communication device, information indicating the configuration.

39. The method of claim 38, wherein the configuration is associated with at least one of a flexible time resource allocation or a flexible frequency resource allocation.

40. The method of claim 38, wherein the configuration indicates scheduling information for the sensing reference signal.

41. The method of claim 40, wherein the scheduling information includes at least one of:
periodic scheduling information,
semi-persistent scheduling information, or
aperiodic scheduling information.

42. The method of claim 40, wherein the scheduling information is transmitted via at least one of:
radio resource control signaling,
medium access control signaling, or
downlink control information.

43. The method of claim 38, wherein the configuration indicates a staggering pattern for the sensing reference signal.

44. The method of claim 43, wherein the staggering pattern indicates frequency locations over multiple symbols of the sensing reference signal.

45. The method of claim 43, wherein the configuration indicates a length of the sensing reference signal based at least in part on a comb size associated with the sensing reference signal.

46. The method of claim 43, wherein a comb size of the staggering pattern is based at least in part on a bandwidth configuration of the wideband structure.

47. The method of claim 46, wherein the comb size is indicated by a table entry corresponding to the bandwidth configuration of the wideband structure.

48. The method of claim 46, wherein the comb size is determined based at least in part on signaling received from a base station.

49. The method of claim 43, wherein frequency locations of the staggering pattern are defined based at least in part on a number of symbols of the sensing reference signal and a comb size of the staggering pattern.

50. The method of claim 43, wherein the staggering pattern spans an entire bandwidth of the wideband structure.

51. The method of claim 43, wherein the staggering pattern spans a sub-band of the wideband structure, and wherein the staggering pattern is used in multiple sub-bands of the wideband structure with a frequency hopping pattern.

52. The method of claim 51, wherein the sub-band is defined based at least in part on a resource block.

53. The method of claim 51, wherein the sub-band is defined based at least in part on a resource block group.

54. The method of claim 43, wherein a plurality of staggering patterns are used for respective sub-bands of the wideband structure.

55. The method of claim 54, wherein the respective sub-bands are defined based at least in part on resource blocks.

56. The method of claim 54, wherein the sub-band is defined based at least in part on resource block groups.

57. The method of claim 38, wherein the configuration indicates a dedicated resource for the sensing reference signal.

58. The method of claim 38, wherein the configuration identifies a symbol-level time domain resource pattern for the wireless sensing signal.

59. The method of claim 38, wherein the configuration identifies a slot-level time domain resource pattern for the wireless sensing signal.

60. The method of claim 38, wherein the configuration indicates a gap for radio frequency switching before the sensing reference signal is transmitted.

61. The method of claim 38, wherein the configuration indicates a gap for radio frequency switching associated with frequency hopping between a first sub-band and a second sub-band during transmission of the sensing reference signal.

62. The method of claim 38, wherein the configuration indicates a sequence for the sensing reference signal.

63. The method of claim 62, wherein the sequence is based at least in part on a sequence used for a channel state information reference signal.

64. The method of claim 62, wherein the sequence is based at least in part on a sequence used for a sounding reference signal.

65. The method of claim 62, wherein the sequence is based at least in part on a pi divided by 2 (π/2) binary phase shift keying modulation scheme.

66. The method of claim 62, wherein the sequence is based at least in part on one or more Zadoff-Chu sequences.

67. The method of claim 62, wherein the sequence is based at least in part on a modified sequence for a channel state information reference signal.

68. The method of claim 38, wherein the sensing reference signal is a downlink signal.

69. The method of claim 38, wherein the sensing reference signal is an uplink signal.

70. A wireless communication device for wireless communication, comprising:
a memory; and
one or more processors operatively coupled to the memory, the memory and the one or more processors configured to:
determine a configuration for a sensing reference signal to be transmitted by the wireless communication device, wherein the configuration is associated with a wideband structure;
transmit the sensing reference signal in accordance with the configuration; and
perform a wireless sensing operation based at least in part on receiving sensor information and based at least in part on the configuration.

71. A network entity for wireless communication, comprising:
a memory; and
one or more processors operatively coupled to the memory, the memory and the one or more processors configured to:
determine a configuration for a sensing reference signal to be transmitted by a wireless communication device, wherein the configuration is associated with a wideband structure; and
transmit, to the wireless communication device, information indicating the configuration.

72. A non-transitory computer-readable medium storing one or more instructions for wireless communication, the one or more instructions comprising:
one or more instructions that, when executed by one or more processors of a wireless communication device, cause the one or more processors to:
determine a configuration for a sensing reference signal to be transmitted by the wireless communication device, wherein the configuration is associated with a wideband structure;
transmit the sensing reference signal in accordance with the configuration; and
perform a wireless sensing operation based at least in part on receiving sensor information and based at least in part on the configuration.

73. A non-transitory computer-readable medium storing one or more instructions for wireless communication, the one or more instructions comprising:
one or more instructions that, when executed by one or more processors of a network entity, cause the one or more processors to:
determine a configuration for a sensing reference signal to be transmitted by a wireless communication device, wherein the configuration is associated with a wideband structure; and
transmit, to the wireless communication device, information indicating the configuration.

74. An apparatus for wireless communication, comprising:
means for determining a configuration for a sensing reference signal to be transmitted by the apparatus, wherein the configuration is associated with a wideband structure;
means for transmitting the sensing reference signal in accordance with the configuration; and
means for performing a wireless sensing operation based at least in part on receiving sensor information and based at least in part on the configuration.

75. An apparatus for wireless communication, comprising:
means for determining a configuration for a sensing reference signal to be transmitted by a wireless communication device, wherein the configuration is associated with a wideband structure; and
means for transmitting, to the wireless communication device, information indicating the configuration.
